(19) United States
(12) Patent Application Publication
(10) Pub. No.: US 2009/0059259 A1
(43) Pub. Date: Mar. 5, 2009

(54) SINGLE PASS DOCUMENT HANDLER WITH OPTIMIZED PERFORMANCE AND EXTENSIBLE DESIGN

(75) Inventor: Michael J. WILSHER, Herts (GB)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/845,375

(22) Filed: Aug. 27, 2007

(51) Int. Cl. G06F 15/00

(52) U.S. Cl. 358/1.13

(57) ABSTRACT

System and methods providing image reading devices having rated throughput capacity substantially equal to half of the rated throughput capacity of the associated printer module. The system includes a plurality of image reading devices, associated buffer storage devices, and a printer module arranged in a fashion allowing for maintaining throughput capacity while reducing overall costs. The image reading devices have individual rated throughput capacities that are substantially equal to half the rated throughput capacity of the printer module in duplex. The output from the image reading devices are loaded into buffer storage devices, from which the printer module is sequentially loaded from the buffer storage devices. The buffer storage devices allow for downgrading the rated throughput capacity of at least some of the image reading devices to approximately half of the associated printer module, thus, allowing for reduced manufacturing and operating costs, and advantageously using commercially available units.

### BACKGROUND

This disclosure is directed to systems and methods that relate to a duplex simultaneous reading apparatus capable of reading a duplex document in an image forming device.

Printers, copiers and other types of image forming devices have become necessary productivity tools for producing and/or reproducing documents. Such image forming devices include, but are not limited to, desktop copiers, stand-alone copiers, scanners, facsimile machines, photographic copiers and developers, multi-function devices and other like systems capable of producing and/or reproducing image data, in either simplex or duplex modes, from an original document, data file or the like.

As the technology expands, configurations of image forming devices are becoming increasingly more capable, and coincidentally increasingly more complex. An objective remains or allowing for greater image production and/or throughput, and reduced operating and production costs, while maintaining image quality. Conventionally, various types of image forming devices used in the reproduction of images require both the initial reading of the images and subsequent printing of the images. Such capabilities depend on the systems themselves, for example, in the modes of operation of the systems and/or the physical complexity of the systems.

To maximize productivity in image forming devices, each component of the image forming device should be sized and/or configured in such a manner to optimize throughput of the particular component in order to attempt to maximize overall throughput capacity of the image forming device. System and device design then strikes a balance between increasing the throughput capacity of the image forming device with, for example, mediating increases in overall costs associated with the image forming device including not only increased device production costs but also increased operating costs due to, for example, increased energy costs associated with an increased throughput, for which the design of the device may not be optimized.

Each component internal to, or associated with, image production in an image forming device should be optimally sized for an expected maximum throughput for the overall system. Specifically, the reading operation should be sized to match the throughput capability of the subsequent printing operation. Limitations in an available throughput of individual output image components, by which images are to be formed, can be analyzed with respect to each individual component. Certain of the components in the image forming device, by their characteristic nature, may tend to impede the overall throughput image forming process to a greater degree than others. It is these individual components upon which a system designer may focus in attempting to optimize an image forming device.

There are many areas of an image forming device that lend themselves to optimization as currently configured and operated. One specific component which may lend itself to optimization is the duplex reading module of an image forming device. Typically, in a single pass document handler, the normal approach is to place a second scan head in the document handler for scanning the second side at the same time as the first side is being scanned. This means that the system or a user does not have to invert a two-sided image bearing medium back for a second scan.

Typically, a single printing module is coupled with a plurality of image reading modules within an image forming device. The overall throughput of the image forming device, in duplex mode, is dependent on a single two-sided image bearing medium consisting of a plurality of images, at least one on a first side and a second side of the media. The first image and the second image are scanned simultaneously, and the subsequent printing of the duplex image on a first side and a second side of the output media are performed sequentially.

In the two-scan-head case, a practical challenge relates to the fact that each of the two scan heads will, in effect, emit image data, possibly simultaneously, as a single sheet is being recorded. To accommodate this dual output of page image data, downstream circuitry for processing and recording the image data must be designed accordingly. For various practical reasons, it is desirable to retain an ability to handle one page image at a time, as in simplex mode.

By placing a second scan head, to scan the second side in a single pass document handler that scans at the rated throughput of the first scan head, which equals the rated throughput of the print engine, the second side scan must be buffered. The buffering of the second side scanned image allows for the sequential printing of the scanned first side image followed by the printing of the scanned second side image by a single print engine of the image forming device. A large inter-document gap is inserted between the printing of the first scanned side and the second scanned side to allow for the transmission of the second scanned side image to the print engine of the image forming device from the buffer.

Not only do single printing modules potentially limit the throughput of image forming devices, but a plurality of image reading modules may also significantly affect operating costs, i.e. energy or component costs. Specifically, a plurality of image reading modules may be physically operated at the same image medium throughput rate of the printing module. However, since a single printing module is employed, the two-sided image reading modules are effectively operated at twice the throughput available to the total throughput of the printing module. In other words, each side could be scanned in twice the time being output at the normal page rate and not affect the rated throughput of the print engine of the image forming device.

It should be recognized that a plurality of lower throughput image reading modules may expend less energy as compared to higher rated throughput image reading modules rated to equal the throughput of the printing module. Operating costs for the reading modules represent a significant portion of the energy operating costs for the image forming device, and also represent excessive manufacturing costs, which are not optimized.

### SUMMARY

As indicated above, a drawback with conventional systems and methods associated with image forming devices may include requirements to size a plurality of image reading modules to equal a throughput of the printing module of an image forming device. Image reading modules are photosensitive devices outputting digital image data related to light detected from an image moving past the location of the image reading module. The duplex image reading modules, reading a first image and a second image, can be operated at half of a rated throughput capacity of the printing module, as a single printing module must operate at higher than the throughput capacity of the image reading modules to allow for duplex inversion since both a first image and a second image, read simultaneously must be printed on the receiving media, sequentially at rated throughput for 100% productivity. By using a single printing module, the productivity of the image forming device remains operationally flexible in being able to cost efficiently handle both simplex and duplex reproducible input media.

It would be advantageous, in view of the above-identified shortfalls, to provide a system, within or related to one or more image forming devices, that would maintain productivity, while reducing operating and manufacturing costs, by providing systems and/or image forming devices with systems, or individual image forming devices with reduced image reading module throughput capacity and increased configuration flexibility.

First and second side image reading modules that match the throughput of the print engine of the image forming device are not required as this would be twice the number of sides in duplex that the image forming device is capable of. First and second side image reading modules with less than the rated throughput of the print engine, i.e., half the rated throughput capacity of the print engine, can be effectively utilized without reducing the overall throughput of the overall image forming device.

Disclosed systems and methods may address the above-identified shortfalls by providing an image forming device with one or more image reading modules, in which each reading module may operate at an optimized overall throughput based on substantially half of the rated throughput of the printing module. Such a configuration would maintain overall throughput while optimizing operating and manufacturing costs for such systems and devices. The one or more image reading modules may be individually sized so that the total throughput capacity of the image reading modules would not be a limiting factor with regard to a total throughput capacity of the image forming device.

In various exemplary embodiments, there may be provided a duplex simultaneous reading apparatus having a first image reading module, and a second image reading module for simultaneously reading a first surface and a second surface of a document. The duplex simultaneous image reading module may include: a selection unit for selecting operation of individual image reading modules from among the one or more image reading modules; a detection unit for detecting any specified pattern image from image data read by the first image reading module and the second image reading module; and a selection unit for selectively inputting the read image data of the first surface of the document and the read image data of the second surface of the document to a first buffer storage device and a second buffer storage device, respectively, wherein the first buffer storage device and the second buffer storage device stores, respectively, the specified pattern image of the first image and the second image of the document; and the first buffer storage unit outputs the read image data of the first surface of the document to a print module, and then the second buffer storage unit sequentially outputs the read image data of the second surface of the document to the print module, wherein the total combined throughput capacity of the first image reading unit and the second image reading unit substantially equals the throughout capacity of the print module.

These and other features and advantages of the disclosed embodiments are described in, or apparent from, the following detailed description of embodiments.

### BRIEF DESCRIPTION OF THE DRAWINGS

Various exemplary embodiments of the disclosed system will be described, in detail, with reference to the following figures, wherein:

FIG. 1 schematically illustrates a block diagram of an exemplary embodiment of a configuration of an image forming device employing a plurality of image reading modules;

FIG. 2 illustrates a timeline of an image forming device configuration employing a single printing module associated with an image forming device and a plurality of image reading modules each with a throughput capacity equal to half that of the printing module; and

FIG. 3 illustrates a timeline of a conventional related art image forming device configuration employing a single printing module associated with an image forming device and a plurality of image reading modules each with a throughput capacity equal to the printing module.

### DETAILED DESCRIPTION OF EMBODIMENTS

The following description of various exemplary embodiments of systems and methods that may be associated with one or more image forming devices including a plurality of image reading modules and a single image printing module, each image reading module with a rated throughput substantially equal to half that of the total throughput of the image printing module for duplex, in the one or more image forming devices, may refer to and/or illustrate components of an electrographic or xerographic image forming device as one specific type of an image forming device with which such systems and/or modules may be associated for the sake of clarity and ease of depiction and description. However, it should be appreciated that, in various exemplary embodiments, systems and methods including a plurality of image reading modules, and a single image printing module, as illustrated, for example, in the figures, with principles disclosed herein, as outlined and/or discussed below, can be equally applied to any known, or later-developed, image forming device within which one or more of such systems may be advantageously accommodated.

For example, the various disclosed exemplary embodiments of the systems and methods may be incorporated with respect to simplex reduction and/or enlargement where traditionally the image reading device operates at the rated throughput capacity of the printing module. The systems and methods disclosed herein may allow for the image reading module to operate at an optimized overall throughput based on substantially half of the rated throughput of the printing module.

The capabilities incumbent in disclosed systems and methods have as one of several objectives maintaining output quantity (throughput) of, and reducing overall costs associated with, image production by, for example, using a plurality of image reading modules, of limited, or lesser individual throughput capacity and cost, which are readily available, with respect to the rated throughput capacity of the printing module.

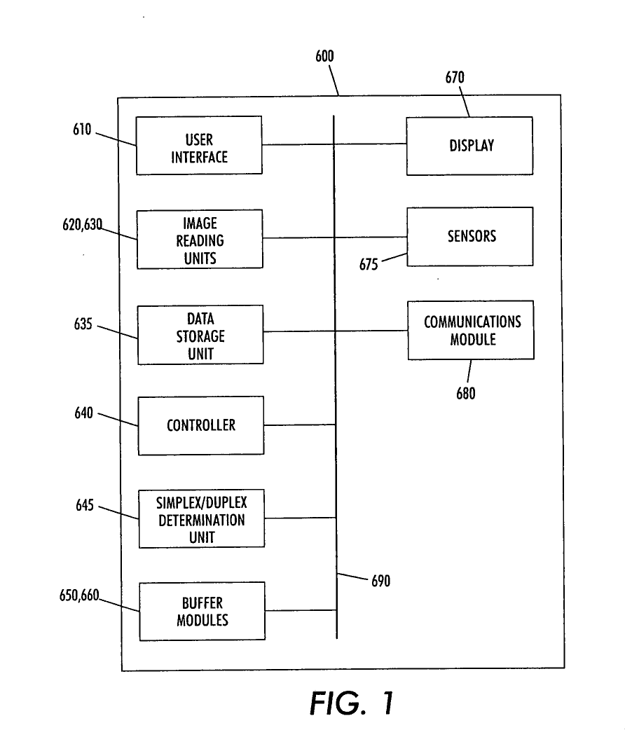

FIG. 1 schematically Illustrates a block diagram of an exemplary embodiment of a configuration of an image forming device 600 employing a plurality of image reading units 620, 630 and buffer storage devices 650, 660. As shown in FIG. 1, the system 600 may include a image source 600, a user interface 610, a first image reading unit 620, a second image reading unit 630, one or more data storage units 635, a controller 640, a simplex/duplex determination unit 645; a first buffer storage device 650, a second storage device 660, a display device 670, one or more sensors 675, a communications device 680, and a data sink 700, all connected via a data/control bus 690. Such data/control bus 690 may include one or more wired or wireless connections to any of the involved devices, units and/or modules.

The system 600 may include a user interface 610 to provide a capability for a user to enter, or be view, any instruction, to include an ability to designate one or more image reading units 620, 630 among a plurality of image reading units in the image forming device. Separately, instructions may be viewable on a dedicated display device 670 associated with the image forming device. It should be appreciated that the user interface 610 is contemplated to allow for presentation and receipt of user messages in a full spectrum of audio and/or visual formats. The user interface 610 may be in communication with the various system components by the data/control bus 690, or otherwise by any means by which data communication between the user interface 610 and the other components of the system 600 may be implemented.

The system 600 may include a controller 640 for monitoring and controlling various operations of the system 600 to effect and/or facilitate execution of any manner of functioning of individual components within the system to include, but not be limited to multiple image reading units 620, 630 and buffer storage devices 650, 660 in coordination among the plurality of modules with which the system may be associated. The controller 620 may be in communication with the various system components by the data/control bus 690, or otherwise by any means by which data communication between the controller 640 and the other components of the system 600 may be implemented.

The controller 640 may receive input from a simple/duplex determination unit 645, one or more sensors 675, and the user interface 610, and provide output to the first and second image reading units 620, 630 and the first and second buffer storage devices 650, 660. Once it is determined, either by means of the user interface 610, the simplex/duplex determination unit 645 or other means associated with the system 600 that a plurality of image reading units may be required, in an image forming device with which the system 600 is associated, the controller 640 may designate multiple image reading unit operations via the simplex/duplex determination unit 645 and provide appropriate input and/or control of various other components, as required.

The system 600 may include a simplex/duplex determination unit 645 that may be used to compare various inputs from a variety of system components and to select appropriate methods of operation based on those determinations, as described above. A simplex/duplex determination unit 645 may receive input from, and may provide input to, the controller 640. If the controller 640, based on various system inputs, indicates that the media is either simplex or duplex, the controller 640 may send an input to energize, de-energize or optimize the image reading units 620, 630 and the buffer storage units 650, 660.

The simplex/duplex determination unit 645 may be in communication with the various system components via the data/control bus 690, or otherwise by any means by which data communication between the determination unit 645 and the other components of the system 600 may be implemented.

The system 600 may include a communications device 680 for communicating, i.e., receiving or transmitting, to local or remote users, additional image forming devices and/or others systems. For example, the communications device 680 may receive user input from a remotely-located user to the system 600. A user may be remotely located from the image forming device with which the system 600 is associated, and user instructions, user interface menu prompts, warnings and messages, may be sent via the communications device 680 to communicate the status of the system 600 to the remotely-located user via a compatible data receiving device (not show). It is contemplated that a local and remote user shall have the same interaction with the system 600 of the image forming device, independent of location. Such communications may be effected, via the communications device 680, with any of the various components of the system 600, or otherwise associated with the image forming device. It is also contemplated that the system 600 may be employed, for example, in a networked system of a plurality of image forming devices that employ additional devices such as binders, sorters, distribution devices, scanners, and the like.

It should be appreciated that communications may be undertaken with various components of the system 600, or otherwise in the image forming device with which the system 600 is associated, by either wired or wireless data exchange systems, as well as any combination thereof. Further, it should be appreciated that communications, as described above, are intended to include web-based network and local area network communications, in addition to remote, and/or local, operation from any manner of information or data exchange device such as, for example, personal computers and/or various other communication devices such as Personal Data Assistants (PDAs), smart phones, and the like. The communications device 680 may be in communication with the various system components via the data/control bus 690

The system 600 may include one or more data storage units 635 to allow for storage of various operating parameters or other operating data. Operating parameters may include, but are not limited to, user instructions received by any means, including via the user interface 610, and the status of the simplex/duplex determination unit 645. It is contemplated that the operating parameters may be stored within the one or more data storage units 635 until such time as the parameters are changed based on the systems and methods described relating to the system 600. The one or more data storage units 635 may be in communication with the various system components via the data/control bus 690, or otherwise by any means by which data communication between the one or more data storage units 635 and the other components of the system 600 or the image forming device may be implemented.

In various exemplary embodiments, an image forming device may include an initiating device that allows a user to initiate an image forming device functions or an image forming operation in the image forming device. Input provided, for example, via the user interface 610, may initialize the functioning of the image forming device with which the system 600 is associated and activate, for example, controller 640 of the system 600. The user interface 610 may be one of several available methods or devices for initiating the image forming device. Once the image forming device is initialized, the various components of the system 600 may determine a requirement for either simplex or duplex operation being required of the image forming device by means of the user interface 610 and/or the controller 640. It is contemplated the user may initialize the image forming device by any means provided, including but not limited to a user interface 610, a wired or wireless Internet based network, and a wired or wireless local area network. Once the image forming device is initialized system 600 may be activated

It should be appreciated that the simplex/duplex determination unit 645 described above, may require some sensed input from one or more sensors 675 of the image forming device. These one or more sensors 675 may be provided as one or more designated image detection sensors, or one or more multi-purpose transport sensors, for detecting the presence of media on a designated transport device of an image forming device in order that a user may be alerted to a potential for disruption of the media.

It should be further appreciated that other options may be provided to a user via the user interface 610 if a system determines, for a given operating mode of the image forming device, that a specific aspect of the simplex/duplex determination unit 645, any transport devices and/or sensor inputs from one or more sensors 675 should automatically inhibit and/or cancel operations, or request information regarding manually inhibiting and/or canceling a particular image forming operation within the image forming device. Any range of such options is contemplated such that, for example, when a specific set of circumstances dictates that an image forming operation should be aborted, such abort may supercede, or be guided by the disclosed systems and methods.

It should be appreciated that, while shown in FIG. 1 as a single composite unit, the system 600 may be either a unit and/or capability internal to an image forming device, internal to any component of an image forming device, or may be separately presented as a stand-alone system, unit or device such as, for example, a separate server connected to an image forming device. Further, it should be appreciated that each of the individual elements depicted as part of the system 600 may be implemented as part of a single composite unit or as individual separate devices, alone or in any combination of devices or functionalities. For example, the simplex/duplex determination unit 645 and controller 640 may be integral to a single composite unit communicating with other components of the system 600. As noted above, it should be appreciated that, while depicted as a separate unit, the simplex/duplex determination unit 645, controller 640, one or more sensors 675, and various other components may be separately attachable to the system as composite multi-function input/output components such as, for example, multi-function devices that include determination unit/controller/sensor capability, all within a single unit with a separate user interface as part of the single composite unit.

It should be appreciated that given the required inputs, software algorithms, hardware circuits, and, or any combination of software and hardware control elements, may be used to implement the individual devices and/or units in the exemplary system 600.

It should be appreciated further that any of the one or more data storage units 635 depicted in FIG. 1, or otherwise as described above, can be implemented using any appropriate combination of alterable, volatile or non-volatile memory, or non-alterable, or fixed, memory. The alterable memory, whether volatile or non-volatile can be implemented using any one or more of static or dynamic RAM, a floppy disk and associated disk drive, a writeable or re-writeable optical disk and associated disk drive, a hard drive/memory, and/or any other like memory and/or device. Similarly, the non-alterable of fixed memory can be implemented using any one or more of ROM, PROM, EPROM, EEPROM and optical ROM disk, such as a CD-ROM or DVD-ROM disk and compatible disk drive or any other like memory storage medium and/or device.

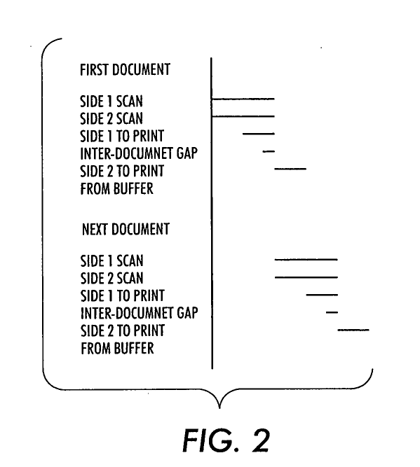

FIG. 2 is an exemplary embodiment reflected in a timeline of operations, wherein the first and second image reading units operate at substantially half the rated throughput capacity of the printer module. It should be appreciated that while FIG. 2 illustrates two image reading units such as the first and second image reading units 620, and 630, depicted in FIG. 1, it is anticipated that any number of image reading devices may comprise the plurality of image reading devices to be incorporated. The image reading devices may have a rated throughput capacity equal to substantially half of the rated throughput of a printer module in the image forming device. For example, the image reading devices may have a individual rated capacity of 25 pages per minute (ppm) while the rated throughput capacity of the printer module has a rated capacity of 50 ppm. The image reading devices may each output to buffer storage devices such as buffer storage units 650, 660 shown in FIG. 1 to allow for temporary storage of an output of each image reading device until such time as the image reading device, at a rated capacity of substantially half of the printer module, has output sufficient data to efficiently load the printer module at the rated capacity of the image reading device. At that time the buffer storage device may be able to effectively load the printer module, a first buffer storage device loads the printer module. Upon completion of the printing of the image data from the first buffer storage device, the second buffer storage device sequentially loads the printer nodule. During the printing of the image data from the second buffer storage device, the first and second image reading units may be available to scan subsequent pages containing duplex data thus the buffers are filled with the next page while emptying the previous page.

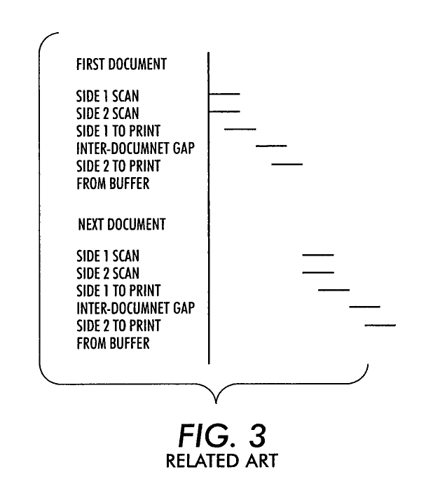

FIG. 3 illustrates a timeline of operations of a device utilizing less efficient, and more costly, higher rated throughput capacity image reading devices. The combined rated throughput capacity of the image reading devices in this case is substantially the rated throughput capacity of the first and second image reading units 620, 630 illustrated in FIG. 1.

The total time required to print a duplex image, as illustrated by FIG. 2, utilizing image reading devices rated at substantially half the rated throughput capacity of the print engine, is substantially equal to the time required to print a duplex image as illustrated by FIG. 3 utilizing image reading devices each rated equal to the rated throughput capacity of the print engine. It should be noted that this applies to duplex mode. In simplex mode the side one image reading device is required to operate at the full rated throughput. The embodiment thus allows for a far less costly and more easily implemented side 2 image reading device at the expense of an additional page buffer.

The above detailed description of exemplary embodiments of methods and system for defining a system, and methods for providing a multiple image reading unit configuration is meant to be illustrative, and in no way limiting. The above detailed description of methods and system is not intended to be exhaustive or to limit this disclosure to any precise embodiments or feature disclosed. Modifications and variations are possible in light of the above teaching. The above embodiments were chosen in order to clearly explain the principles of operation of the systems and methods according to the disclosure and their practical application to enable others skilled in the art to utilize various embodiments, potentially with various modifications, suited to a particular use contemplated. Also, various presently unforeseen or unanticipated alternatives, modifications, variations or improvements therein may be subsequently made by those skilled in the art, and are also intended to be encompassed by the following claims.

What is claimed is:

1. A system for processing an image in an image forming device comprising: a single print engine; and
a plurality of image reading devices with some devices having an individual throughput capacity less than a rated throughput capacity of the single print engine,
wherein the plurality of image reading devices read image data at a first rate, read image data is input directly from the plurality of image reading devices to the single print engine at the first rate to produce output images at a second rate and the second rate does not exceed the rated throughput capacity of the single print engine.

2. The system of claim 1, wherein the individual throughput capacity of the each of the plurality of image reading devices in duplex is substantially half of the rated throughput capacity of the single print engine.

3. The system of claim 1, wherein the total individual throughput capacity for the plurality of image reading devices does not exceed the rated throughput capacity of the single print engine.

4. The system of claim 1, wherein the plurality of image reading devices are disposed on opposite sides of an image bearing medium handling path.

5. The system of claim 1, further comprising a determination unit for determining operation of one or more individual image reading devices from among the plurality of image reading devices.

6. The system of claim 5, wherein the determination unit automatically determines operation of more than one individual image reading device from among the plurality of image reading devices based on operating parameters of the image forming device.

7. The system for processing an image according to claim 5, further comprising one or more sensors associated with at least one of a transport path or at least one of the image reading devices from among the plurality of image reading devices,
wherein the determination unit automatically determines operation of more than one individual image reading device from among the plurality of image reading devices based on an input from at least one of the one or more sensors.

8. The system for processing an image according to claim 5, wherein the determination unit determines operation of more than one individual image reading device among the plurality of image reading devices based on a received user input.

9. The system of claim 5, wherein the determination unit determines a single image reading device among the plurality of image reading devices during simplex operation.

10. The system of claim 5, wherein the determination unit determines a single image reading device among the plurality of image reading devices during duplex operation.

11. The system of claim 1, further comprising a plurality of buffer modules wherein read image data is input directly from the plurality of image reading devices to the plurality of buffer modules.

12. The system of claim 11, wherein read image data is output from the plurality of buffer modules to the single print engine.

13. A method for processing an image in an image forming device comprising:
reading first image data from an input image document with a first image reading device at a first rate;
reading second image data from an input image document with a second image reading device at the first rate;
transmitting the first image data from the first image reading device directly to a print engine at the first rate;
transmitting the second image data from the second image reading device directly to the print engine at the first rate; and
producing an output image in the print engine by accepting the first and second image data transmitted from the first and second image reading devices at the first rate and producing the output image at a second rate.

14. The method of claim 11, wherein the plurality of image reading devices have an individual throughput capacity less than a rated throughput capacity of the print engine.

15. The method of claim 11, wherein the plurality of image reading devices have an individual throughput capacity equal to substantially half a rated throughput capacity of the print engine.

16. An image forming device including the system of claim 1.

17. A xerographic image forming device including the system of claim 1.
